(19) United States
(12) Patent Application Publication
(10) Pub. No.: US 2001/0049605 A1
(43) Pub. Date: Dec. 6, 2001

(54) Service supply method and service supply system

(75) Inventors: Hiroshi Tanaka, Kaisei-machi (JP); Kazuo Shimura, Kaisei-machi (JP); Takeshi Ohkubo, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/864,457

(22) Filed: May 25, 2001

(30) Foreign Application Priority Data
May 26, 2000 (JP) 156603/2000

(51) Int. Cl. G06F 17/60

(52) U.S. Cl. 705/1; 705/10

(57) ABSTRACT

A review service system capable of supplying a review service desired by a general practitioner such that the service fits desired conditions. Supplier information such as a location and an amount of spare time concerning each of a plurality of medical specialists is stored in a database in advance. The medical specialists are suppliers capable of supplying review services. A management center comprises: a supplier information acquire unit for acquiring supplier information; a customer information acquire unit for acquiring customer information concerning the review service desired by the general practitioner as the customer; and a matching unit for listing the medical specialists capable of supplying the review service that fits the conditions desired by the general practitioner from the database, deciding a medical specialist who best fits desired conditions, and allowing the customer and the supplier to correspond with each other, based on the supplier information and the customer information.

### BACKGROUND OF THE INVENTION

1. Field of the Invention

The present invention relates to a service supply method and a service supply system, which allow a customer who intends to receive a supply of desired services and a supplier capable of supplying the services desired by the customer to correspond with each other, and which make it possible to offer the desired services.

2. Description of the Related Art

Today in a remarkably expanding service industry, a great number of customers who receive a supply of services and suppliers who supply the services exist in various fields.

However, the services are not necessarily supplied as desired by the customer, or supplied timely at a desired fee and quality.

For example, in the case where a diagnosis is made by using a radiation image in a medical field, a reviewing skill is required for reviewing the radiation image. Since not all general practitioners are necessarily able to review radiation images accurately, there are cases where the general practitioner may make a diagnosis by referring to a report by a medical specialist (hereinafter referred to as a review doctor) having a capability of reviewing the radiation image. In this case, after the general practitioner photographs the radiation image, the general practitioner has to pass the radiation image to the medical specialist, who contracts with the general practitioner, for review. However, if the medical specialist does not have any spare time, the general practitioner cannot obtain a review report by the desired time, and this maybe detrimental to the diagnosis.

### SUMMARY OF THE INVENTION

The present invention has been created in view of the above-described circumstances. The object of the present invention is to provide a method and a system capable of supplying a service desired by a customer, so that the service suits the customer's wishes in terms of a supply time and a fee.

With regard to various services, including a service associated with medical attention or a service associated with care such as, for example, a medical service directly connected with medical treatment and a service indirectly connected with medical attention, a first aspect of the service supply method of the present invention is a service supply method, in which a customer receiving the various services, and at least one of a plurality of suppliers capable of supplying the service desired by the customer, are linked and the supply of the desired service from the supplier to the customer is enabled, which comprises the steps of:

acquiring supplier information via a network concerning at least one of the times when the service of each supplier can be supplied, a quality of service that each supplier can supply, a location of each supplier, and a fee constituting good value for the supply of the service;

acquiring customer information concerning the service desired by the customer; and

allowing customers who desires the supply of the service, and suppliers capable of supplying the desired service, to correspond with each other based on the supplier information and the customer information acquired.

A second aspect of the service supply method of the present invention is a service supply method, in which a customer receiving the various services and at least one of a plurality of suppliers capable of supplying a service desired by the customer are linked and the supply of the desired service from the supplier to the customer is enabled, which comprises the steps of:

acquiring supplier information concerning at least one of the times when the service of each supplier can be supplied, a quality of service that each supplier can supply, a location of each supplier, and a fee constituting good value for the supply of the service;

storing the acquired supplier information in a database;

acquiring customer information concerning the service desired by the customer; and

allowing the customer who desires supply of the service and the supplier capable of supplying the desired service to correspond with each other based on the acquired customer information and the supplier information read from the database.

In the foregoing, allowing the customer who desires supply of the service and the supplier capable of supplying the desired service to correspond with each other implies that the supplier capable of supplying the desired service is selected and the selected supplier and the customer who desires the supply of the service are linked.

In linking the customer and the supplier, for example, suppliers capable of supplying the desired service, which satisfies conditions such as the quality and the fee desired by the customer, among the selected suppliers, may be immediately linked with the customer. Alternatively, the items of information concerning the selected suppliers are informed to the customer, and the customer may be allowed to decide on a desired supplier.

Note that when there is no suppler capable of supplying the desired service, the customer may be notified of such a fact. Alternatively, desired conditions are relaxed, the suppliers who fit the relaxed conditions are selected, and the customer may be notified of the selection result.

A service supply system of the present invention is a system executing the above-described method, that is, a service supply system, which links a customer receiving various services and at least one of a plurality of suppliers capable of supplying a service desired by the customer and thus enables supply of the desired service from the supplier to the customer, the service supply system comprising:

supplier information acquiring means for acquiring supplier information concerning at least one of the time when the service of each supplier can be supplied, a quality of service that each supplier can supply, a location of each supplier, and a fee constituting good value for the supply of the service;

customer information acquiring means for acquiring customer information concerning the service desired by the customer; and

matching means for allowing the customer who desires the supply of the service and the supplier capable of supplying the desired service to correspond with each other based on a plurality of items of supplier information and customer information acquired.

It is preferable that the service system of the present invention comprises a database storing the supplier information.

According to the present invention, the supplier information is acquired, such as the time when each service of a plurality of suppliers can be supplied, and the customer information concerning the service desired by the customer is acquired. Furthermore, the customer who desires the supply of the service and the supplier capable of supplying the desired service are allowed to correspond based on a plurality of items supplier information and the customer information acquired. Therefore, it is possible to supply the service desired by the customer so as to suit the service to the time and the fee that the customer wishes. Thus, compared to an individual contract between the supplier and the customer, the service supplier can effectively spend his/her spare time, while the customer can reduce the number of times when he/she cannot receive the desired service.

If the service supply system is designed such that the information concerning the suppliers capable of supplying the service is registered in the database in advance, it is possible to smoothly retrieve a supplier capable of supplying the desired service that suits the conditions desired by the customer.

### BRIEF DESCRIPTION OF THE DRAWINGS

FIG. 1 is a block diagram showing a structure of a first embodiment (review service system) of the present invention.

FIG. 2 is a block diagram showing a structure of a second embodiment (review report typing service system) of the present invention.

FIG. 3 is a block diagram showing a structure of a third embodiment (home medical practice service system) of the present invention.

FIG. 4 is a block diagram showing a structure of a fourth embodiment (care service system) of the present invention.

FIG. 5 is a block diagram showing a structure of a fifth embodiment (review service system and review report typing service system) of the present invention.

### DESCRIPTION OF THE PREFERRED EMBODIMENTS

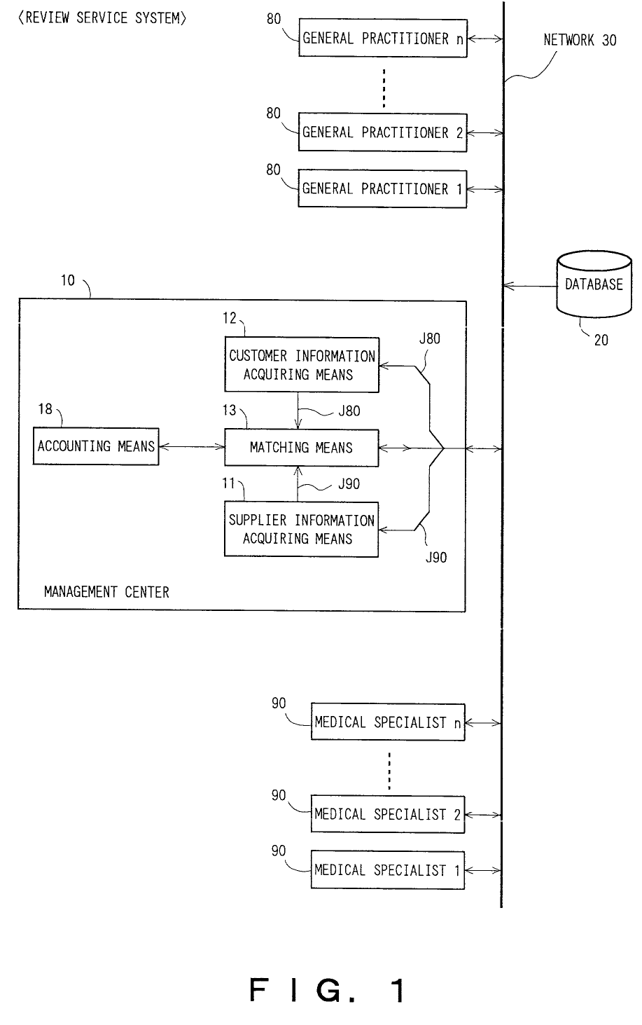

Hereinafter, embodiments of the present invention will be described in detail with reference to the accompanying drawings. FIG. 1 is a block diagram showing a structure of a system of a first embodiment of the present invention. The system shown in FIG. 1 is a review service system linking a general practitioner as a customer and a medical specialist (radiotherapist, clinician and the like) as a supplier who reviews a radiation image in response to a request of the general practitioner.

As shown in FIG. 1, the review service system comprises: a management center 10 including supplier information acquiring means 11 for acquiring supplier information J90 concerning medical specialists (1, 2, . . . , n) who are suppliers 90 supplying the review service, customer information acquiring means 12 for acquiring customer information J80 concerning the review service (one mode of the desired service) desired by general practitioners (1, 2, . . . , n) as customers 80, and matching means 13 for allowing the general practitioner who desires the supplying of the review service and the medical specialist capable of supplying the review service to correspond with each other based on a plurality of supplier information item J90 and customer information items J80 acquired; a database 20 storing the supplier information J90 concerning the time when each medical specialist can supply the review service, a quality of service that each medical specialist can supply, a location of each medical specialist, and the fee, constituting good value for the supply of the review service by each medical specialist, and the like; and a network 30 enabling data transmission among each general practitioner (customer 80), each medical specialist (supplier 90), the database 20 and the management center 10. Note that the database 20 may be provided in the management center 10.

Accounting means 18 for executing accounting processing in accordance with the supply of the review service is further provided in the management center 10. The accounting means 18 5 executes the accounting processing after the matching means performs correspondence between the general practitioner who desires the supplying of the review service and the medical specialist capable of supplying the review service, and there view service is actually supplied to the general practitioner.

Registration of the supplier information J90 with the database 20 may be performed via the management center 10. In this case, an input terminal (not shown) is provided for the medical specialist, and the medical specialist is allowed to input the supplier information J90 with the input terminal via the network 30. The registration of the supplier information J90 may be performed with the database 20 after the information is properly arranged. Alternatively, an operator of the management center 10 acquires the information of the medical specialist by telephone or the like, and the operator may register the result in the database 20. Moreover, the registration may be directly performed by the medical specialist with the input terminal (not shown) without via the management center 10.

The time when each medical specialist can supply the review service may be the particular time, which can be calculated, for example, from a time schedule of each medical specialist.

The quality of the review service that each medical specialist can supply should be represented by, for example, a rank, years of experience or a field of speciality.

The location of each medical specialist may be either an accurate address, or a rough district name including the city, the town, the village or the prefecture.

The fee constituting good value for the supply of the review service may be represented by a unit cost per review service or by a time unit. The fee may include a reward for the medical specialist.

Next, an operation of the review service system having the above-described structure will be described.

First, the general practitioners 1 to n who receive the review service and the medical specialists 1 to n who supply the review service make contracts with the management center regarding the supply of the review service in advance.

The supplier information J90, such as a time schedule and a reviewing capability of each of the medical specialists 1 to n as the supplier 90 supplying the service, is registered in the database 20 in advance. If a change is made for the registered 20 contents, it is preferable that the changed contents are registered every time the change is made.

When a request for review service of the radiation image is input to the management center 10 from the general practitioner as the customer 80, the customer information acquiring means 12 acquires the customer information J80, such as the location of the general practitioner, the desired review time, the quality of the review and the desired fee. At this time, a desired priority and essential conditions, such as the review time and a distance between the general practitioner and the medical specialist, may also be acquired. The acquired customer information J80 and the like are input to the matching means 13. The customer information J80 and the like may be input with the input terminal (not shown) provided for the general practitioner. Alternatively the customer information J80 may be input with the input terminal (not shown) provided in the management center 10 by telephone between the general practitioner and the operator of the management center 10.

The matching means 13 instructs the supplier information acquiring means 11 to read out the supplier information J90 concerning the medical specialist from the database 20. The supplier information acquiring means 11 reads out the supplier information J90 from the database 20, and inputs the read out supplier information J90 to the matching means 13.

The matching means 13 retrieves the supplier information J90 which is input thereto, in other words, which is read out from the database 20, and selects/lists the medical specialists who fit the desired conditions of the general practitioner (such as quality and cost) shown by the customer information J80. The matching means 13 subsequently decides a medical specialist who best fits the desired condition of the customer among the listed medical specialists, and informs the general practitioner of the information concerning the decided medical specialist.

The general practitioner who acquired the information transmits the radiation image, which is desired for review, to the medical specialist who has been introduced via the network. The medical specialist to whom the radiation image has been transmitted reviews the radiation image to make a review report as electronic data, and transmits the electronic data to the general practitioner who desired the review service. In addition, the medical specialist transmits information concerning a time spent for the review service to the matching means 13.

The matching means 13 inputs the time spent for the review service transmitted from the medical specialist, and a time unit fee registered with the database 20 to the accounting means 18. The accounting means 18 calculates an actual fee based on the input time and the time unit fee, and calculates a total cost by adding an intercession fee by the management center 10 and the like to the foregoing actual fee. The accounting means 18 inputs the total cost to the matching means 13. The matching means 13 charges the general practitioner for the total cost.

The number of the review services performed and the fee per review registered with the database 20 are input to the accounting means 18, and the actual fee may be calculated based on the input number of reviews and the fee per one review.

As described above, in the review service system having the above described structure, the general practitioner can receive the review service that fits the desired conditions from any medical specialist even if no individual contract is made between the general practitioner and the medical specialist.

Particularly, when the general practitioner is under an individual contract with the medical specialist, the general practitioner cannot receive the supplying of the review service at the desired time when the medical specialist is busy, and this may cause inconvenience to his/her diagnosis. On the other hand, in this system, the matching means 13 of the management center 10 allows any medical specialist, who is capable of supplying the review service at the time desired by the general practitioner, to correspond with the general practitioner by the retrieval of the supplier information J90. Therefore, inconvenience is not caused in the diagnosis of the general practitioner and the medical specialist can spend their spare time effectively. Thus, the present invention can bring about significant effects.

Moreover, the information concerning each medical specialist capable of supplying the review service is registered in the database 20. Accordingly, the medical specialist, who is capable of supplying the review service that fits the conditions desired by the general practitioner, can be easily retrieved, and as a result, thus improve the efficiency of the review service system.

In addition, a new intercession service (new business) can be constructed as well, in which a medical specialist who is capable of supplying the review service that the general practitioner desires is introduced to the general practitioner.

Note that, in the above-described embodiment, among the listed medical specialists, the matching means 13 decides the medical specialist who best fits the conditions desired by the customer, and the information concerning the decided medical specialist is sent to the general practitioner. The way of deciding the medical specialist is not limited to this. For example, all of the information concerning the listed medical specialist maybe sent to the general practitioner, and the general practitioner may decide on the medical specialist who actually supplies the review service.

Note that, if no medial specialist is listed who fits the general practitioner's wish, such a fact maybe sent to the general practitioner. Alternatively, for example, a notification to the effect that there are medical specialists who fit the general practitioner's wish if the priority of the desired conditions is changed, or if one of the desired conditions is excluded, may be sent to the general practitioner, and the information concerning the medical specialists who can be listed may be also sent to the general practitioner.

In the above-described embodiment, the transmission of the radiation image and the transmission of the review report are made directly between the general practitioner and the medical specialist. However, the way of transmitting the radiation image and the review report between them is not limited to this, and the transmission may be made via the matching means 13 provided in the management center 10.

Further, the information transmitted from the general practitioner to the medical specialist may include not only the radiation image but also information that can be referred to for the review diagnosis, such as patient monitor information (an electrocardiogram and the like) and interview information.

The above-described first embodiment is illustrated and described herein as embodied in the system where the general practitioner and the medical specialist are linked via the management center 10 so that the medical specialist is capable of supplying the review service of the radiation image desired by the general practitioner. However, the present invention is not limited to such a system. Another embodiment of the present invention will be described as follows.

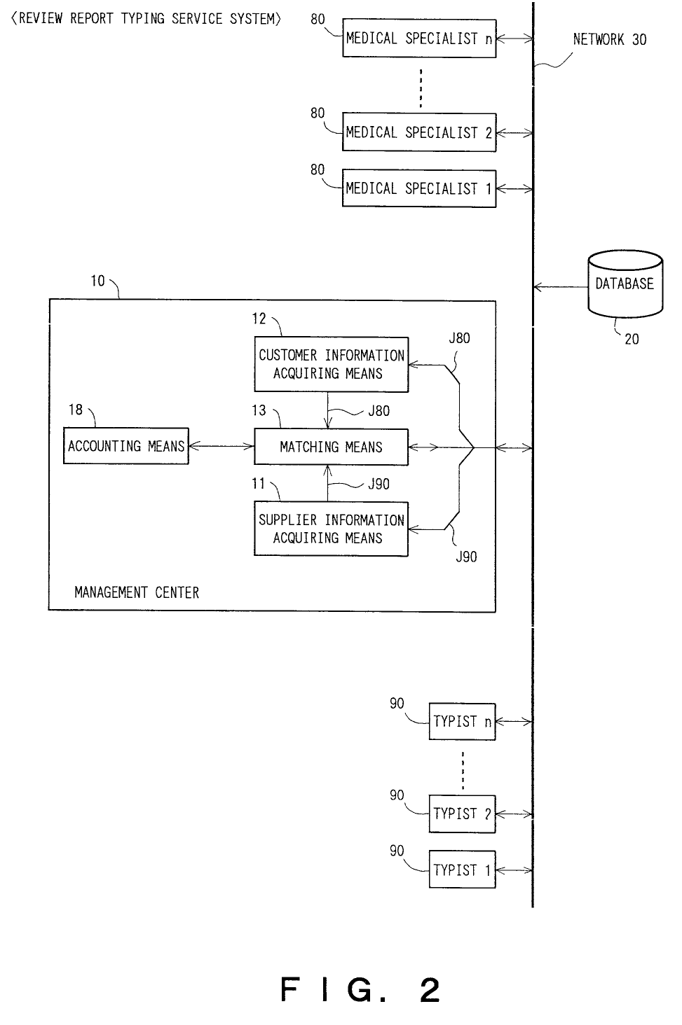

FIG. 2 is a block diagram showing a structure of a review service supply system of a second embodiment of the present invention. The review service supply system shown in FIG. 2 is a review report typing service system in which the medical specialist as the customer 80 and a typist as the supplier 90 are linked. The medical specialist is a person who reviews the radiation image and performs voice recording of a review report, and the typist is a person who makes document data from the review report of the voice recording by the medical specialist. As shown in FIG. 2, the structure of the review report typing service system itself is identical to that of the review service system shown in FIG. 1.

In the review report typing service system, the supplier information J90 concerning the time when each typist can supply the typing service, a quality of the typing service that each typist can supply, a location of each typist and a fee constituting good value for the supplying of the typing service, is first stored into the database 20.

The medical specialist as the customer 80 reviews the radiation image and records voice data of the review report, and requests the management center 10 to make the document data from the recorded voice data. Then, the management center 10 lists and selects the typists who fit the conditions desired by the medical specialist based on the information concerning the typists registered with the database 20, and sends the information concerning the typists to the medical specialist.

The medical specialist who has acquired the information transmits the voice data to a desired typist. The typist who has received the transmitted voice data makes the document data of the review report based on the voice data. Then, the typist transmits the document data that he/she has made to the medical specialist, and transmits the information concerning the time spent for supplying of the typing service to the matching means 13.

The management center 10 performs the accounting processing (cost charging processing) regarding the typing service in accordance with the operation of the above-described review service system.

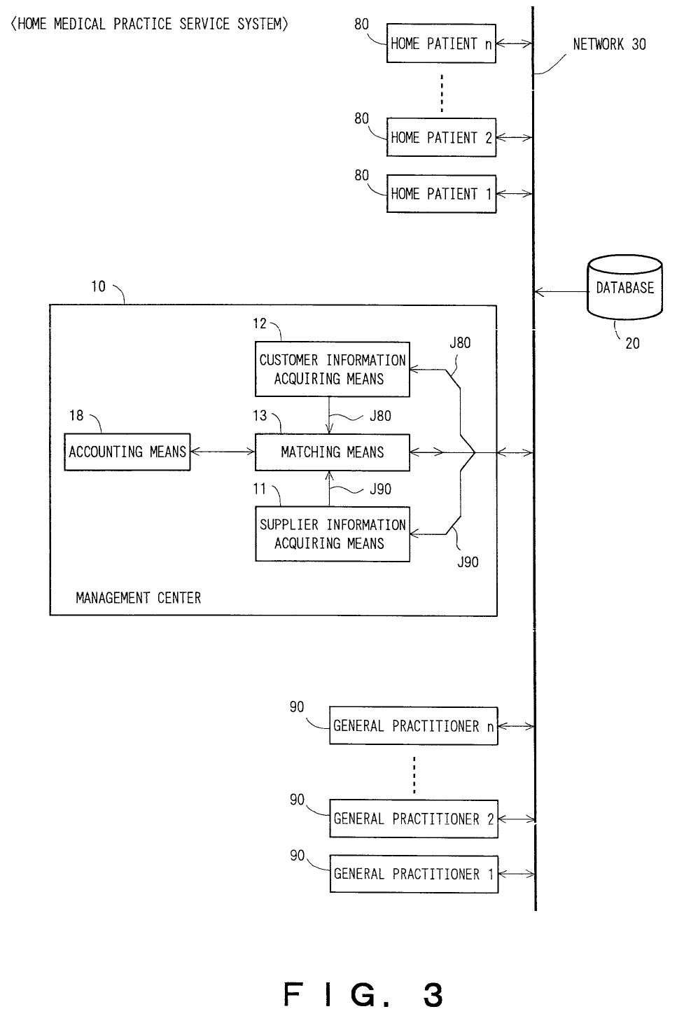

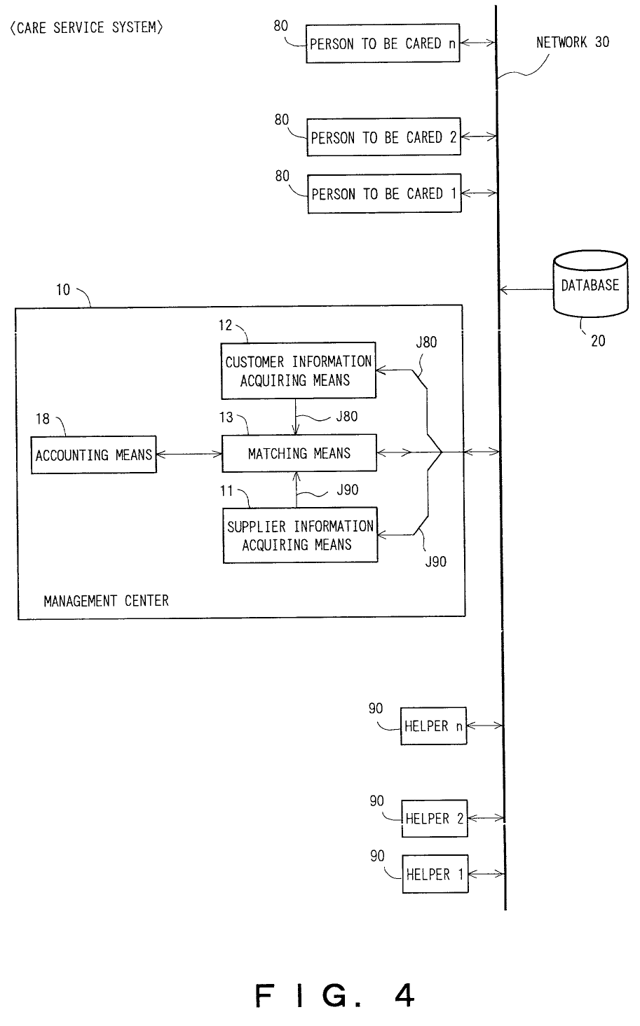

FIG. 3 is a block diagram showing a structure of a system of a third embodiment of the present invention. The system shown in FIG. 3 is a home medical diagnosis service system in which a home patient as the customer 80 and the general practitioner as the supplier 90 are linked. The home patient is a person who desires a home medical diagnosis, and the general practitioner is a person who makes a remote medical diagnosis for the home patient. As shown in FIG. 4, the system itself is identical to that of the review service system shown in FIG. 1.

In the home medical practice service system, the supplier information J90 concerning the time when each general practitioner can make a medical diagnosis, a quality of each general practitioner (years of experience, a field of specialization and the like), a location of each general practitioner and a fee constituting good value for the supplying of the medical diagnosis service, are first stored in the database 20.

The home patient, as the customer 80, requests the home medical diagnosis from the management center 10. Then, the management center 10 lists and selects the general practitioners who fit the conditions desired by the home patient based on the information concerning the general practitioners registered with the database 20, and sends information concerning the selected general practitioners to the home patient.

The home patient who has acquired the information communicates with a desired general practitioner. The home patient receives the remote medical diagnosis via the network 30, in which the home patient is interviewed by the general practitioner via a TV telephone, or his/her health condition is checked by confirmation of the electrocardiogram and by transmitting the sound from a stethoscope. When the remote medical diagnosis is completed, the general practitioner transmits the information concerning the time spent for the supply of the diagnosis service, the diagnosis contents and the like to the matching means 13.

The management center 10 performs the accounting processing (cost charging processing) regarding the diagnosis service in accordance with the operation of the above-described review service system.

FIG. 4 is a block diagram showing a structure of a system of a fourth embodiment of the present invention The system shown in FIG. 4 is a care service (welfare service) system in which a person to be cared for as the customer 80 and a care helper as the supplier 90 are linked. The person to be cared for is the one who receives care, and the care helper is the one who supplies the person to be cared for with the care service. As shown in FIG. 4, the system structure itself is identical to that of the review service system shown in FIG. 1.

In the care service system, the supplier information J90 concerning the time when each helper can supply the care service, a quality of the care service that each helper can supply, a location of each helper and a fee constituting good value for the supply of the care service is first stored into the database 20.

The person to be cared for as the customer 80 requests the supply of the care service of the management center 10. Then, the management center 10 lists and selects the care helpers who fit the conditions desired by the person to be cared for based on the information concerning the care helpers registered with the database 20, and sends the information concerning the selected care helpers to the person to be cared for.

The person to be cared for who has received the information communicates with a desired care helper, and requests that the helper visit the person to give the care service to him/her. In this case, the person to be cared for refers to the locations of the helpers, and selects a care helper who satisfies the conditions (such as the quality of the care and the desired fee) and who is closest to the location of the person to be cared for. Therefore, the care helper who satisfies his/her wish can visit the location of the person to be cared for in a short time.

When the management center 10 selects the care helper who best fits the wishes of the person to be cared for, the management center 10 may instruct the care helper to visit the location of the person to be cared for immediately. When the supply of the care service is completed, the care helper transmits the information concerning the time spent for the supplying of the care service, the service contents and the like to the matching means 13.

The management center 10 performs the accounting processing (cost charging processing) regarding the care service in accordance with the operation of the above-described review service system.

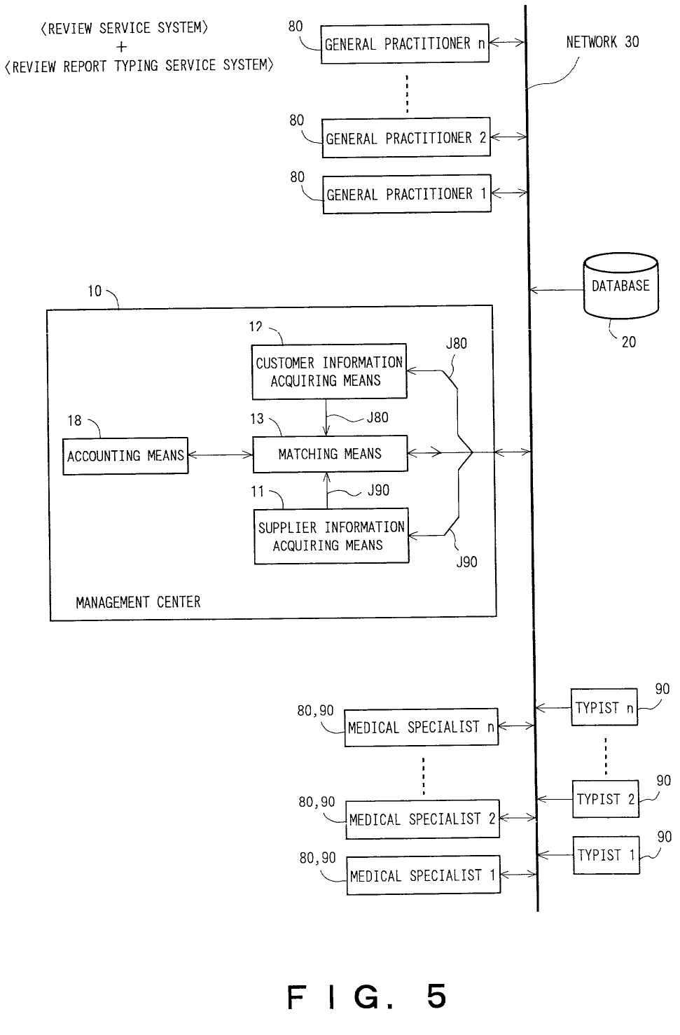

FIG. 5 is a block diagram showing a structure of a system of a fifth embodiment of the present invention. The system shown in FIG. 5 is one in which the review service system shown in FIG. 1 and the review report typing service system shown in FIG. 2 are combined.

In this case, each medical specialist is equivalent to any one of the customer 80 and the supplier 90. Description of the flow of each service is omitted because it has already been given in each of the foregoing embodiments.

Preferred embodiments of the present invention have been described. However, the present invention is not limited to the above-described embodiments.

For example, each of the above-described embodiments shows an example of a system in which a customer who desires the supply of the service and a supplier capable of supplying the desired service are allowed to correspond and link with each other such that the supply of the desired service to the customer is enabled. Such service includes: the service directly connected with medical treatment such as review of a radiation image and a home medical diagnosis; a service such as a typing service associated with the medical attention, in which document data of a review report is utilized for the medical treatment, the document data being a result of the service although it is not directly connected with the medical treatment; and a service associated with care (welfare) . However, the kind of service may different.

In each of the above-described embodiments, the database 20 is provided and the supplier information J90 concerning the supplier who supplies the service is registered in the database 20 in advance. However, in the case where the database 20 is not provided, a constitution may be adopted such that the supplier information acquiring means 11 acquires the supplier information J90 via the network 30 every time the customer requests supply of the service, or alternatively, the operator of the management center 10 inquires about the contracted supplier of the supplier information J90 by telephone and the like, and inputs the result using an input terminal.

In addition, each of the above-described embodiments is system in which a plurality of customers 80 and a plurality of suppliers 90 have multiple contracts with the management center 10. However, the customer in the present invention may be one person.

What is claimed is:

1. A service supply method, in which a customer receiving services and at least one of a plurality of suppliers capable of supplying a service desired by the customer are linked, and supply of said desired service from said supplier to said customer is enabled, comprising the steps of:
acquiring supplier information concerning at least one of a time when each of said suppliers can supply said service, a quality of service that each of said suppliers can supply, a location of each of said suppliers, and a fee constituting good value for the supply of said service via a network;
acquiring customer information concerning said service desired by said customer; and
allowing the customer who desires the supply of said desired service and the supplier capable of supplying the desired service to correspond with each other based on a plurality of items of said supplier information and said customer information acquired.

2. A service supply method, in which a customer receiving services and at least one of a plurality of suppliers capable of supplying a desired service desired by the customer are linked and supply of said desired service from said supplier to said customer is enabled, comprising the steps of:
acquiring supplier information concerning at least one of a time when each of said suppliers can supply said service, a quality of service that each of said suppliers can supply, a location of each of said suppliers, and a fee constituting good value for the supply of said service;
storing the acquired supplier information in a database;
acquiring customer information concerning said service desired by said customer; and
allowing the customer who desires the supply of said desired service and the supplier capable of supplying the desired service to correspond with each other based on said acquired customer information and said supplier information read out from said database.

3. The service supply method according to any one of claims 1 and 2, wherein said service is a service associated with medical attention or a service associated with care.

4. A service supply system, in which a customer receiving services and at least one of a plurality of suppliers capable of supplying a service desired by the customer are linked, and supply of said desired service from the supplier to said customer is enabled, comprising:
supplier information acquiring means for acquiring supplier information concerning at least one of a time when each of said suppliers can supply said service, a quality of service that each of said suppliers can supply, a location of each of said suppliers, and a fee constituting good value for the supplying of said service;
customer information acquiring means for acquiring customer information concerning said service desired by said customer; and
matching means for allowing the customer who desires the supply of said desired service and the supplier capable of supplying the desired service to correspond with each other based on a plurality of items of said supplier information and said customer information acquired.

5. The service supply system according to claim 4, said system further comprising:
a database for storing said supplier information.

6. The service supply system according to any one of claims 4 and 5, wherein said service is a service associated with medical attention or a service associated with care.
